(19) United States
(12) Patent Application Publication
(10) Pub. No.: US 2003/0234945 A1
(43) Pub. Date: Dec. 25, 2003

(54) Color process tint guide

(76) Inventors: James A. Sebastian, Chappaqua, NY (US); Michael McGinn, Brooklyn, NY (US)

Correspondence Address: Thomas A. O'Rourke, Bodner & O'Rourke, LLP, Suite 108, 425 Broadhollow Road, Melville, NY, 11747, US

(21) Appl. No.: 10/384,389

(22) Filed: Mar. 7, 2003

Related U.S. Application Data
(60) Provisional application No. 60/362,342, filed on Mar. 7, 2002.

(51) Int. Cl. H04N 1/60

(52) U.S. Cl. 358/1.9; 358/527; 358/518; 358/504

(57) ABSTRACT

The present invention relates to improvements in color print guides for use in selecting colors. The tint guide of the present invention may be formed from a three dimensional model of the three primary colors that make up a section of a fan deck. The colors cyan, magenta and yellow (CMY) may be used. This combination of colors can display a full range of process colors. There may be three other similar models. One additional model can be cyan, magenta and black. A third can be cyan, yellow and black and the fourth can be magenta, yellow and black.

This application is based on provisional patent application Serial No. 60/362,342 filed Mar. 7, 2002.

### FIELD OF THE INVENTION

The present invention is directed to improvements color representation and selection in, for example, process color printing and color representation for use in the printing arts and elsewhere where color selection is important or desired.

### BACKGROUND OF THE INVENTION

Color printing is a process that typically employs the use of three colors and/or black in combination to create a pallette of colors for use in printing any number of products. One of the problems with the traditional color printing has been the inability of the printer and designer or to accurately represent a large variety of colors. Printing of colors is frequently performed by a series of dots that form a color to the eye. When there are a number of small dots on a substrate, the eye tends not to see the interstices between the dots and perceives the combination of the dots as a solid color. For example, the color gray may be represented in the prior art as a plurality of black dots on a white paper or other substrate. The dots will appear gray to the viewer. The quantity of black dots compared to the amount of white substrate will determine whether the color seen is a dark gray or a lighter version. When other colors are depicted the process is typically similar. For example, dots of up to three of the three primary colors can be applied to a substrate by any suitable means. The color obtained will depend on the number of dots for each of the primary colors. The greater the quantity of dots of one color the stronger that color will be in the overall combination.

One of the problems that have been traditionally incurred using the prior art methods has been an inability of producing or reproducing a full range of colors. Typically, prior art methods could not produce incremental changes in the colors of less than about 5%. As a result, there were a number of shades of color that could not be readily reproduced. Designers would envision a particular color for a work and in many instances, there was frequently an inability of the printers to reproduce the color exactly. This problem has most frequently occurred in the area of process color printing.

Process color printing, also called 4-color process, is method usually used for printing full color photographs and complex images. Instead of selecting a pre-mixed ink for each color, the image is broken up into percentages of 4 standard colors: Cyan, Magenta, Yellow and Black (CMYK). When the 4 plates combine, the full color image can be reproduced. Although near exact color is very achievable, it can be difficult, and takes a great deal of effort. The only way to know exactly how the color in the final job will look like, is to see a proof, a proof that was printed on the same machine that final job will be output from. This is called a Match Print. A laser print, even from the printer, does not show accurate color, because the CMYK breakdown will print differently on each machine depending on its calibration.

### OBJECT OF THE INVENTION

It is an object of the invention to provide an improved method of using colors in printing processes including process color printing.

It is an object of the present invention to provide an improved process color printing method.

It is also an object of the present invention to create colors with process tint combinations.

It is another object of the invention to provide an improved fan deck for matching colors.

It is still another object of the invention to provide a means of matching colors using a fan deck.

It is a further object of the invention to provide an improved fan deck of a full range of color tints for use with a printing process.

It is a still further object of the invention to provide an improved color print guide.

It is also an object of the invention to provide a color print guide that may be produced using direct to plate methods.

It is a further object of the invention to provide a new light range of colors.

It is another object of the invention to provide a full range of “light” colors in a color print guide that may be produced using direct to plate methods.

It is a still further object of the present invention to provide additional two color plus black combinations that have not been heretofore attainable using the prior art methods.

### SUMMARY OF THE INVENTION

The present invention relates to improvements in color print guides for use in selecting colors. The tint guide of the present invention may be formed from a three dimensional model of the three primary colors that make up a section of a fan deck. The colors cyan, magenta and yellow (CMY) may be used. This combination of colors can display a full range of process colors. There may be three other similar models. A second additional model can be cyan, magenta and black. A third can be cyan, yellow and black and the fourth can be magenta, yellow and black.

The model of the present invention may be depicted as a cube. Each axis of the model or cube stands for one of the independently varying primaries in a range from 0% to 100%. In order to represent the three-dimensional color space in two dimensions the three dimensional color space is sliced into a plurality of arrays, preferably arrays of color tint samples. Each array may be cut into individual pages that may be bound together to form a fan. The colors on the fan may be used as a benchmark for reproducing colors on an offset printing press.

The present invention permits effective mixing of colors in a methodical way that was not heretofore possible. The present invention also provides a greater number of color samples because the incremental differences between the samples are less than the 5% of the prior art. The present invention also eliminates errors caused by hand mixing since it provides much more accurate digital process that can work with any percent increments between adjacent colors.

### BRIEF DESCRIPTION OF THE DRAWING

FIG. 1 is a three dimensional model of cyan, magenta and yellow (CMY)

FIG. 2 is the three dimensional model of FIG. 1 sliced into 12 arrays of color tint samples.

FIG. 3 is a representative example of one of the arrays of the model of FIG. 2.

FIG. 4 shows how the array of FIG. 3 may be sliced into six pages.

FIG. 5 is a representative arrangement of the pages of the array arranged in a fan deck.

FIG. 6 shows the color combinations that may form additional models of the type shown in FIG. 1.

FIG. 7 shows an arrangement of the fan decks made from the color combinations of FIG. 6 arranged together in a single fan with color stripes designating the respective color combinations of the fan.

FIG. 8 shows a representation of one side of the fan deck of FIG. 7 showing the full range colors on one side.

FIG. 9 shows a representation of the preferred embodiment where the opposite side of the fan deck of FIG. 7 depicts the light range colors.

FIG. 10 shows a representative page of the fan deck of FIG. 7 showing the tint values for each of the three colors of that section of the deck.

FIG. 11 shows a computer screen with a representative color.

FIG. 12 shows a computer printer printing an accurate color copy of the subject matter on the computer screen of FIG. 11.

FIG. 13 shows the matching of the printed copy of the computer screen to the colors on the fan deck.

FIG. 14 shows two representative colors that are nearly the same but made from different combinations of tint on combination of which may be more stable for certain applications than the other.

FIG. 15 shows how colors can be matched using a side by side comparison.

FIG. 16 shows the formation of the color gray by two methods.

FIG. 17 shows the formation of another color using gray color replacement.

FIG. 18 shows a chart of gray color replacement with black.

FIG. 19 shows an example of two colors using the process of the present invention to minimize color shifting.

FIG. 20 shows a second example of two colors using the process of the present invention to minimize color shifting.

### DETAILED DESCRIPTION OF THE INVENTION

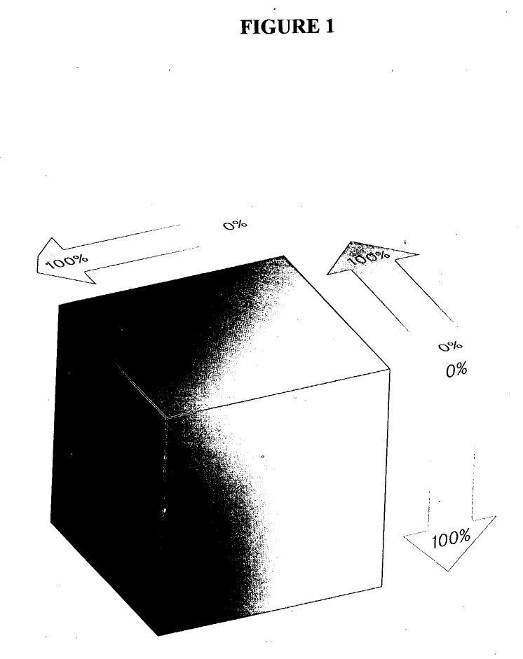

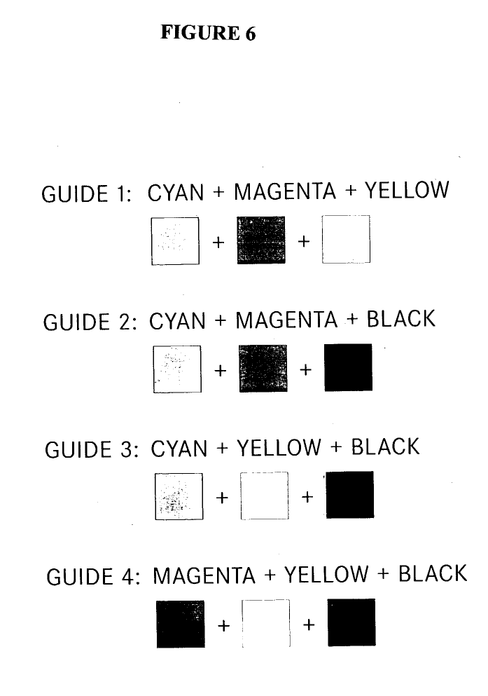

As seen in FIG. 1, the tint guide of the present invention may be formed from a three dimensional model of the three primary colors that make up a section of a fan deck. In this Figure, the colors cyan, magenta and yellow (CMY) are depicted. This combination of colors can display a full range of process colors. There may be three other similar models. One additional model can be cyan, magenta and black. A third can be cyan, yellow and black and the fourth can be magenta, yellow and black (See FIG. 6).

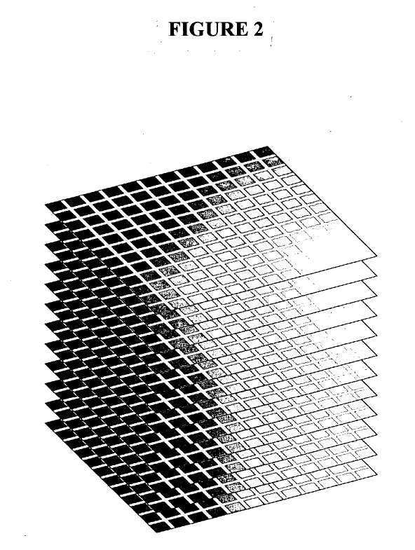

Each axis of the model of FIG. 1 stands for one of the independently varying primaries in a range from 0% to 100%. FIG. 1 is a two dimensional representation of the model for CMY and displays the full gamut of CMY color space. In order to represent the three-dimensional color space to two dimensions the three dimensional color space is sliced into one or more arrays. In a preferred embodiment there are 12 arrays of color tint samples. See FIG. 2. If desired, a greater or lesser number of arrays can be created if desired. If a greater number of arrays is created each color in the array will have a smaller variation from its neighboring color the more arrays there are. Thus, a 20 array slice will produce adjacent colors that vary less than the adjacent colors in a 12 array slice which in turn will produce adjacent colors that vary less than the adjacent colors in a 6 array slice.

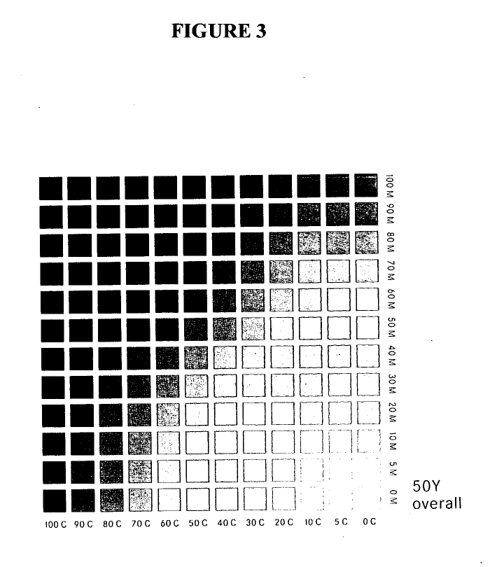

FIG. 3 shows a representative array formed by the slicing of the model of FIG. 1. Each of the 12 array of the example of FIG. 2 may, if desired for ease of use, have the cyan and magenta values laid out along the two axes. The yellow value in each of array will remain constant for that array. In this Figure the yellow value is 50%. Depending on the number of slices the percentage of yellow in each array will vary from 0% to 100% and the difference in yellow from each array to the next adjacent array will be greater the fewer arrays there are. The more arrays there are in the slicing. the difference in the percentage of yellow from one array to the next adjacent array will be less.

If the slicing of the model of Figure one is done in a vertical manner instead of the horizontal manner shown in FIG. 1 the constant color in each sheet of the array will vary depending on the vertical plan that is formed by the slice. For example, if the slice is taken in the vertical plan at an angle parallel to the magenta arrow, the cyan and yellow values could be laid out along the two axes as the magenta value in each of the arrays so formed would remain constant for each array. If the slice is taken in the vertical plan at an angle parallel to the cyan arrow, the magenta and yellow values could be laid out along the two axes as the cyan value in each of the arrays so formed would remain constant for each array. As with yellow, depending on the number of slices the percentage of cyan or magenta in each array will vary from 0% to 100% and the difference in cyan or magenta respectively from each array to the next adjacent array will be greater the fewer arrays there are. The more arrays there are in the slicing the difference in the percentage of cyan or magenta from one array to the next adjacent array will be less. It will be appreciated by those skilled in the art that the number of array in any given model is theoretically limitless as there are infinite variations in the colors formed by the combination of cyan magenta and yellow.

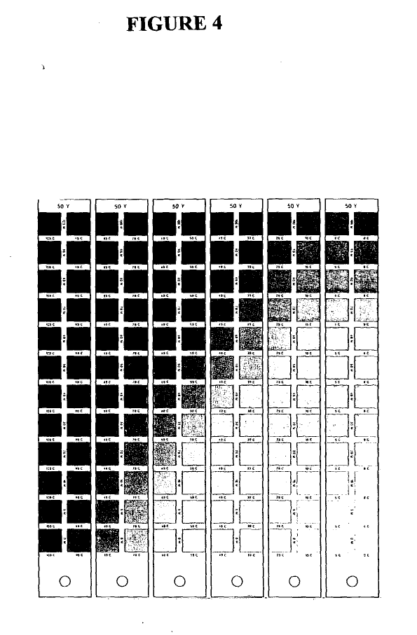

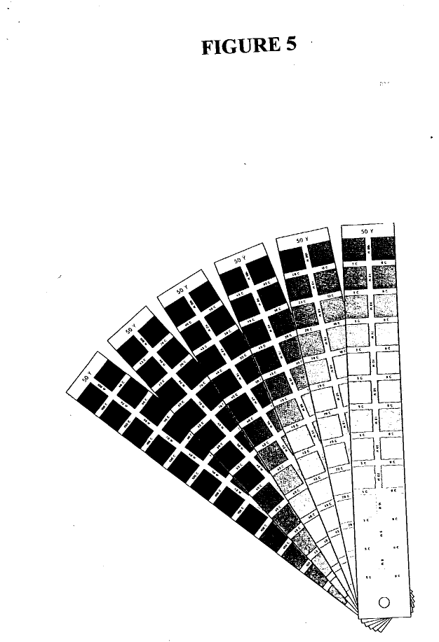

If a fan deck formed from the arrays is desired, each array can be sliced into one or more pages. It has been found that six pages form a fan deck that is manageable by the user (See FIG. 4). These pages may be assembled as a fan deck as shown in FIG. 5. Preferably, the fan deck is opened from left to right as shown in FIG. 5, for ease of use. FIG. 6 shows the four guides that may be included in a single fan if desired. The first guide would be based on combinations of cyan, magenta and yellow as discussed above. A second guide could be based on cyan, magenta and black. A third guide could be based on cyan, yellow and black. A fourth guide could be based on magenta yellow and black. Each of the guides 2 through 4 would be arranged and formed as discussed above with respect to guide 1.

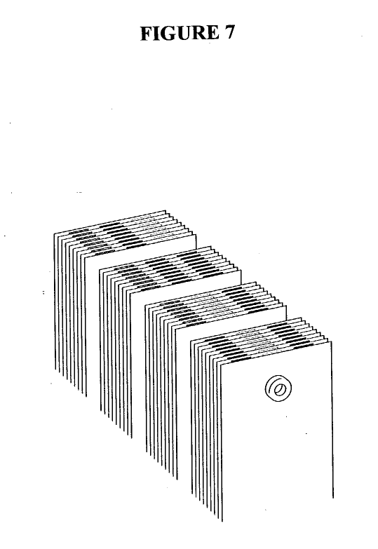

As noted above, guide 1 featuring CYA, displays a full gamut of process color in one guide. Guides 2-4 contain two color plus black combinations based on gray component replacement (GCR) as described below. Every tint combination in guide 1 can be replaced by one from guides 2, 3, or 4. Using these three guides to specify tint colors will result in less color shift on the printing press. No four color (CMTK) tint combinations are used because it has been found that generally every color in the process color gamut can be produced using only three or fewer process colors. The advantage of using the fewest possible tints to print a color tint combination are a more stable color on the press and less ink buildup. For easy identification an edge of one or more sides of the fan deck may be identified with color stripes of its respective colors. Preferably, the color stripes may be on the binding end. See FIG. 7.

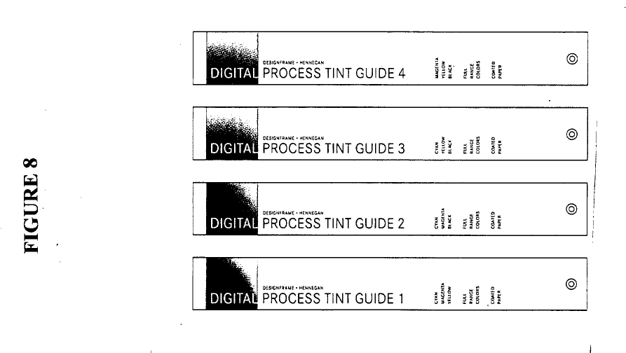

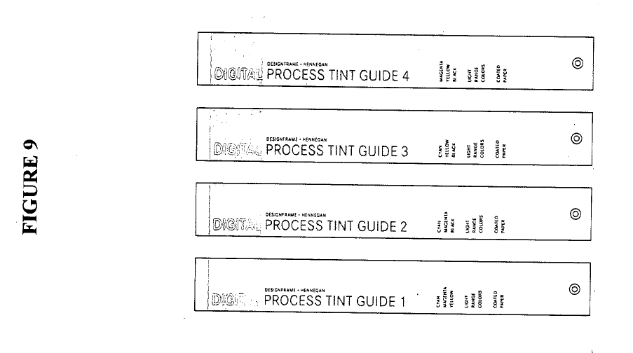

In a preferred embodiment, each fan deck may be provided with full range colors on one side and light range colors on the other. Examples of light range colors are pale colors as shown in FIG. 9 and differ from full range colors which are shown in FIG. 8. Light range colors have traditionally been difficult if not impossible to print with the typical film based plate making. Film based plate making required a 3% dot as a minimum. Anything smaller would not show up. With the precision of direct-to-plate technology, the light range colors can be printed with great accuracy. The tint guide of the present invention permits the display of the light range color more completely than heretofore been possible.

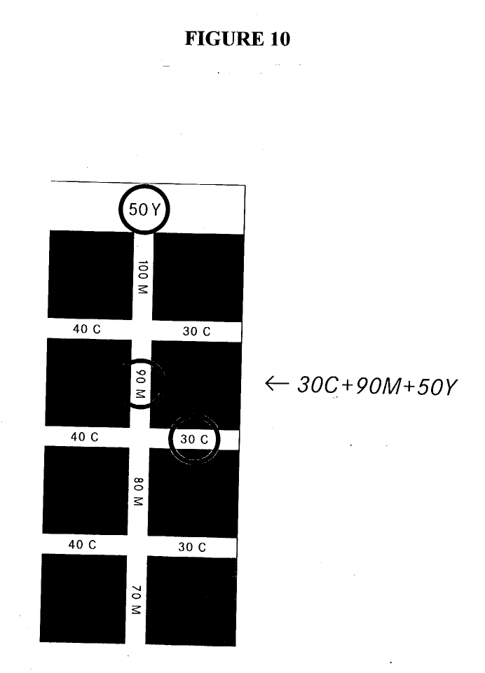

Each page of the fan deck may display combinations of three process colors. To specify the tint formula for a swatch the tint values for each component are included. In the example shown in FIG. 10 the value for one color appears at the top of the card. The others are read below and beside the swatch. In this example, the color indicated is 30% cyan, 90% magenta and 50% yellow. The totals do not add up to 100% because they are not measuring the total percentage of each color in the swatch in relation to the other colors present but are measuring how much cyan is present where the amount of cyan possible ranges from 0% (no cyan) to 100% of the possible cyan. The amount of magenta present can range from 0% to 100% of the possible magenta. The amount of yellow is 50% of the total amount of yellow present. As with the other two colors, the amount of yellow can range from 0% to 100% as well.

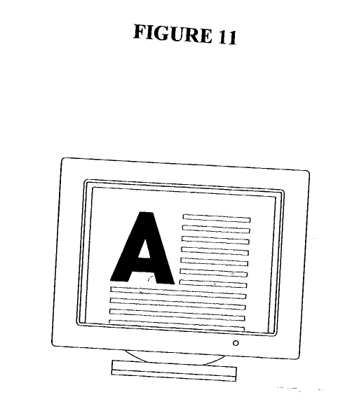

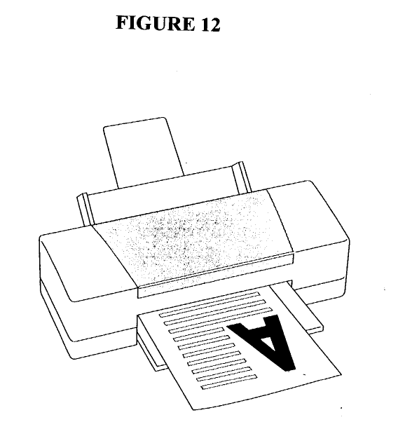

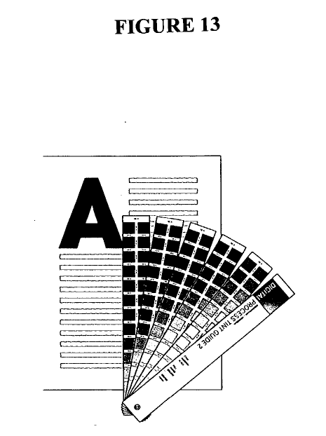

The tint process guide of the present invention can be used as described in the following example. In today's design world, a designer working on a project typically is working on a computer. On the computer screen the designer views a document (FIG. 11). This document will have a color usually selected by the designer. Unfortunately, the colors shown on the screen do not typically appear the same way when printed on a computer's printer. When the document is printed (FIG. 12) the designer compares the color to the color on the computer screen and may have to make adjustments to the settings on the computer color to get the printer to print the color desired. When the color of the printout is approved, the printed version acts as the benchmark for the colors to ultimately be printed. The cyan, magenta, yellow, black (CMYK) formula that produces a benchmark color on a computer's printer cannot typically produce the same color in conventional offset printing. Although computer printers and offset printers both use CMYK inks, the printing technologies, the print stock used and he inks are all quite different. For each tint color in the document the tint guide of the present invention is reviewed to find the closest match to the benchmark color. The color process tint formula identified by the closest match can be used as the formula to reproduce the selected color. In the event the benchmark color desired falls between two color samples on the guide, the formula may be extrapolated from the adjacent formulas because the colors in the guide are arranged in uniform steps (FIG. 13). For best results, the colors are preferably matched under a 5000 degree Kelvin light source. Finally, the computer files that are used by the computer's printer are adjusted so that the formula for the color that is desired from the tint guide is identified. It will be appreciated by those skilled in the art that there are other ways of working. However, in each of these other ways there is a need to select a benchmark.

Guides 2, 3, and 4 described above can display a greater number of colors in closer steps. Also, their two color plus black combinations provide colors that are even more stable on a press than the CMY colors of guide 1. This is due to the issue of color shift and grey color replacement. In the traditional four color process printing ink densities are frequently adjusted upwardly or downwardly to improve the appearance of the images. Several types of tones are particularly sensitive. These include flesh tones, wood tones, neutrals and the client's product are usually the critical elements on a page. In many instances, the color balance on the printing form is adjusted to improve their rendering. Such adjustments may affect other process colors on the printing form, including tint combinations. The result of all these adjustments, as well as normal process variations, is known as process shift.

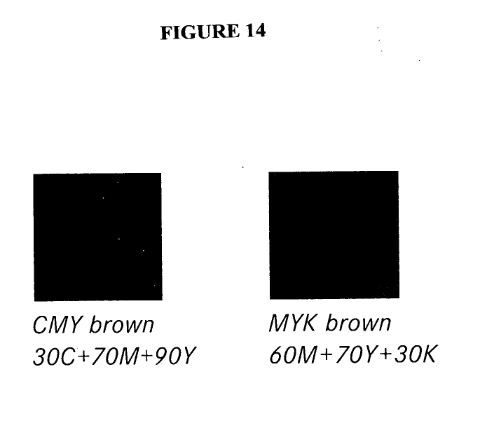

Color shift can become a significant problem where a tint combination occurs across a two page spread in a publication. colors may vary from one page to the next for a variety of reasons. Color shift problems can be minimized by employing process tint combinations that are inherently more stable. For example, in FIG. 14, the two browns appear quite similar but were generated from two different combinations. The CMY brown is from guide 1 while the MYK brown is from guide 4 and is an alternative formula that is actually more stable on a press.

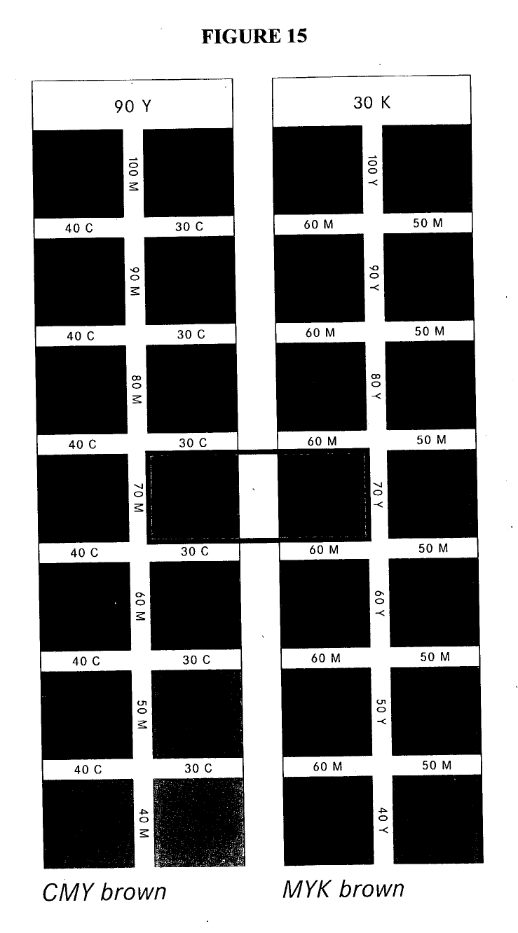

FIG. 15 shows a side by side comparison of two browns in the tint guide whereby the formulas for each of the browns are completely different. It has been found that when the CMY brown shifts 10% in any direction it either becomes to red or too green which results in a very different color. See FIG. 15. Alternatively, if there is a 10% shift in any direction in the MKY brown the tint is still brown related to the specified color.

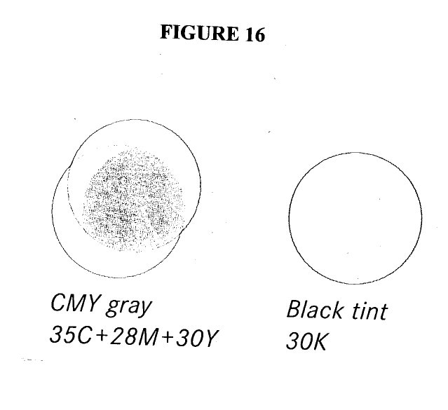

MKY brown has been found to have a better tolerance for color shift because of gray component replacement. Cyan, magenta and yellow when mixed in approximately equal percentages produce a gray. See FIG. 16. FIG. 16 shows a gray created by using a CMY tint combination and the corresponding tint of black. While the CMY gray will be the least stable of all process tint combinations, black makes a very stable gray which is not subject to a color shift because it has no hue. In gray component replacement the CMY gray component of a color is replaced with a tint of black.

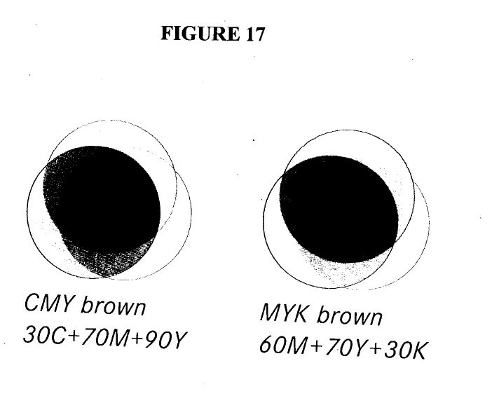

In FIG. 17, there is a brown example where magenta and yellow are dominant thereby contributing most of the “color” to the brown. The role of cyan or black in each brown is mostly to darken and gray the color. While cyan has hue, black does not. In CMY brown any shift in cyan, magenta or yellow affects the hue of the brown. The balance of process primaries creating the brown are easily thrown off. In the MYK version, fluctuations in the black will only darken or lighten the brown. Shifts in magenta or yellow will affect the color but it will still be perceived as a similar brown.

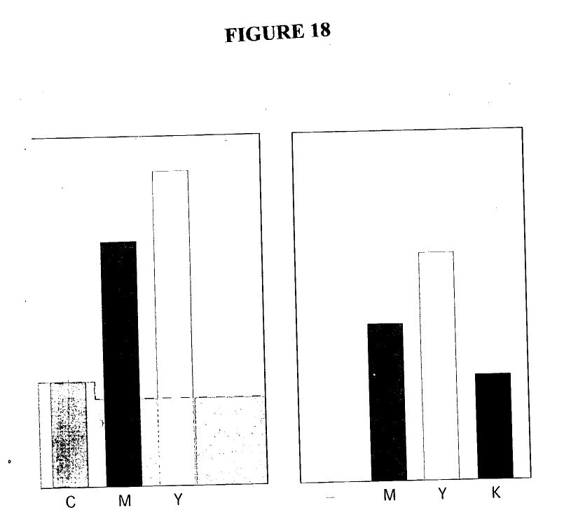

Gray component replacement preserves the dominant hue of a process tint combination and replaces the CMY gray component with black. In FIG. 18 the gray area of the first chart represents the portions of cyan, magenta and yellow that create the gray component of the CMY brown. The second chart in FIG. 18 shows black used to provide the gray component. Cyan is eliminated and magenta and yellow have been reduced. Gray component replacement provides a more stable color as discussed above and less ink is used overall. Guides 2-4 use the gray component reduction.

The present invention can be used to minimize color shifting. In one embodiment if you have a bench mark color to match, no matter what the source guides 2-4 may be used. They provide colors less affected by the color shift. If a color is chosen from guide 1 (CMY) the following steps may be used:

1) determine which process primary has the smallest percentage. This is the color that will be eliminated.

2) Turn to the portion of the tint guide that features the remaining two process primaries plus black and find a matching color.

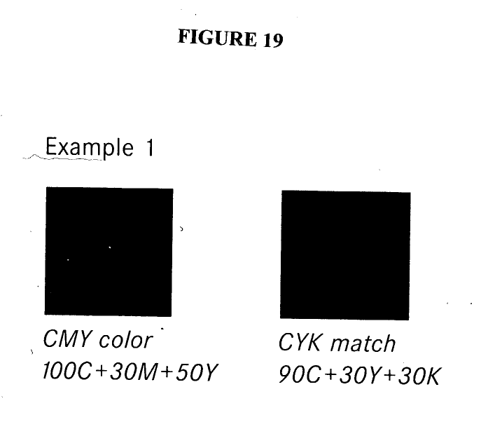

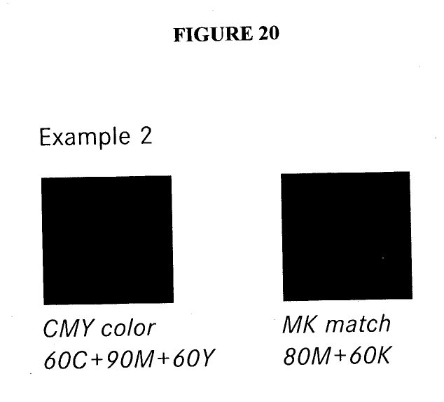

Example 1 (FIG. 19) is an example of this procedure. In this example, cyan and yellow are dominant in the CMY color. Magenta has the smallest percentage and can be dropped and the matching color from guide 3 (CYK) will be used instead as it will prove to be more stable on the press. In FIG. 20 one process primary dominates, in this case magenta. often both minor process primaries can be eliminated and replaced with black. When all three process primaries are equal or nearly equal the color is mostly gray. In this instance the solution will be one where a black dominates with minimal amounts of one or two process primaries to adjust the hue. The identity of the guide used is a very subjective judgment where a color is close to neutral.

I claim

1. A process tint guide comprising a three dimensional model of three primary colors, said model being generally a cube and wherein each axis of the model of represents one of the independently varying primaries in a range from 0% to 100%, said model having been sliced into a plurality of two dimensional arrays of color tint samples such that each array has two primaries with a range of 0% to 100% and the third primary is constant for that particular array.

2. The process tint guide according to claim 1 wherein one primary is cyan, a second is magenta and the third is yellow.

3. The process tint guide according to claim 1 wherein one primary is cyan, a second is magenta and the third is black.

4. The process tint guide according to claim 1 wherein one primary is cyan, a second is yellow and the third is black.

5. The process tint guide according to claim 1 wherein one primary is magenta, the second is yellow and the third is black.

6. The process tint guide according to claim 1 wherein said array is sliced into one or more pages.

7. The process tint guide according to claim 6 where each of said pages forms a fan deck.

8. The process tint guide according to claim 7 wherein said fan deck has a full range of colors on one side of each page and a light range of colors on the opposite side of each page.

9. The process tint guide according to claim 7 wherein there is a first section wherein one primary is cyan, a second is magenta and the third is yellow, a second section wherein one primary is cyan, a second is magenta and the third is black, a third section wherein one primary is cyan, a second is yellow and the third is black, and a fourth section wherein one primary is magenta, the second is yellow and the third is black.

10. A process for determining a color benchmark comprising viewing a work on a computer screen, said work having at least one color, printing said work with a printer connected to said computer, comparing the printed color to the color on the computer screen, optionally making adjustments to the settings on the computer color to get the printer to print the color desired,
when the color of the printout the appropriate color, using the printed version as the benchmark for the colors to ultimately be printed, using a process tint guide to find the closest match in the guide to the benchmark color, said guide comprising a three dimensional model of the three primary colors, said model being generally a cube and wherein each axis of the model of represents one of the independently varying primaries in a range from 0% to 100%, said model having been sliced into a plurality of two dimensional arrays of color tint samples such that each array has two primaries with a range of 0% to 100% and the third primary is constant for that particular array.
using guide as the formula to reproduce the selected color.

11. The process according to claim 10 wherein said printer is an offset printing press

12. The process according to claim 11 wherein the colors are matched under a 5000 degree Kelvin light source.

13. A method of minimizing color shifting in a printing process comprising selecting a bench mark color to match from a CMY guide;
determining which process primary has the smallest percentage and eliminating that color.
finding a matching color in a tint guide that features the remaining two process primaries plus black.

14. A process according to claim 13 where one process primary dominates and eliminating both process primaries and replacing them with black.

15. A method of making a process tint guide comprising forming a three dimensional model of three primary colors, said model being generally a cube and wherein each axis of the model of represents one of the independently varying primaries in a range from 0% to 100%, slicing said model into a plurality of two dimensional arrays of color tint samples such that each array has two primaries with a range of 0% to 100% and the third primary is constant for that particular array.

16. The method according to claim 15 wherein one primary is cyan, a second is magenta and the third is yellow.

17. The method according to claim 15 wherein one primary is cyan, a second is magenta and the third is black.

18. The method according to claim 15 wherein one primary is cyan, a second is yellow and the third is black.

19. The method according to claim 15 wherein one primary is magenta, the second is yellow and the third is black.

20. The method according to claim 15 wherein said array is sliced into one or more pages.

21. The method according to claim 20 where each of said pages forms a fan deck.

22. The method according to claim 21 wherein said fan deck has a full range of colors on one side of each page and a light range of colors on the opposite side of each page.

23. The method according to claim 21 wherein there is a first section wherein one primary is cyan, a second is magenta and the third is yellow, a second section wherein one primary is cyan, a second is magenta and the third is black, a third section wherein one primary is cyan, a second is yellow and the third is black, and a fourth section wherein one primary is magenta, the second is yellow and the third is black.
